(19) United States
(12) Patent Application Publication
(10) Pub. No.: US 2019/0014522 A1
(43) Pub. Date: Jan. 10, 2019

(54) TERMINAL DEVICE, BASE STATION DEVICE, COMMUNICATION CONTROL METHOD, AND PROGRAM

(71) Applicant: SHARP KABUSHIKI KAISHA, Sakai City, Osaka (JP)

(72) Inventors: HIROYUKI SAGA, Sakai City (JP); TAMOTSU SATOH, Sakai City (JP); HIDEAKI SHINMEI, Sakai City (JP); KATSUTOSHI ISHIKURA, Sakai City (JP); ATSUSHI YAMAZAKI, Sakai City (JP); HIROKAZU KOBAYASHI, Sakai City (JP)

(73) Assignee: SHARP KABUSHIKI KAISHA, Sakai City, Osaka (JP)

(21) Appl. No.: 15/748,768

(22) PCT Filed: Jul. 13, 2016
(86) PCT No.: PCT/JP2016/070666

§ 371 Date: Jan. 30, 2018

(30) Foreign Application Priority Data
Aug. 21, 2015 (JP) 2015-164079

(51) Int. Cl. H04W 36/20; H04W 36/06; H04W 36/00; H04W 72/04; H04W 16/14

(52) U.S. Cl. CPC H04W 36/20; H04W 36/06; H04W 16/14; H04W 72/0453; H04W 36/0005

(57) ABSTRACT

A communication unit is configured to perform communication using a first frequency band or a second frequency band different from the first frequency band. A wireless environment measuring unit is configured to detect interference of radio waves used for the communication. A communication control unit is configured to control the communication. The communication control unit is configured to transmit, to a base station device which performs communication using the second frequency band, interference information about a frequency band in which the wireless environment measuring unit has detected interference or wireless environment information including a request for change of a frequency band used for the communication, the transmission being performed in a case that interference is detected in the first frequency band.

### TECHNICAL FIELD

The present invention relates to a terminal device, a base station device, a communication control method and a program, and particularly, to a wireless communication system used for mobile phone networks.

Priority is claimed on Japanese Patent Application No. 2015-164079, filed Aug. 21, 2015, the content of which is incorporated herein by reference.

### BACKGROUND ART

With the development of wireless communication technology, wireless communication is used in various ways. One of various usages is tethering. Tethering is a function of a wireless communication terminal to relay communication of other electronic apparatuses which can be connected to a wireless local area network (LAN) to a public land mobile network (PLMN). The wireless terminal device (referred to as a tethering terminal hereinafter) is connectable to a PLMN and is an electronic apparatus having a base station function of a wireless LAN. For example, the tethering terminal is a mobile phone (including a so-called smartphone) having a wireless LAN function. For example, other electronic apparatuses (referred to as wireless LAN terminals) which can be connected to a wireless LAN include a personal computer (PC), a tablet terminal device, and the like.

As a communication scheme between a base station device and a tethering terminal which constitute a PLMN, utilization of License Assisted Access (LAA) using LTE is under discussion. LAA is a communication scheme employing Long Term Evolution (LTE) using an unlicensed band as a frequency band. In the following description, an unlicensed band may be called an LAA band. When communication performed using a different network, for example, a wireless LAN, has been detected, a base station device performs communication using LAA such that such communication is not obstructed. In communication using LAA (LAA communication), a frequency band different from a frequency band used in communication through a different network is used. However, there are cases in which the base station device cannot detect wireless LAN communication performed between a tethering terminal and a wireless LAN terminal when the tethering terminal is located near a cell edge. The cell edge is the boundary of a cell which is a range that radio waves from the base station device reach. Furthermore, there are cases in which another communication apparatus, for example, an access point (AP) of a wireless LAN (referred to as a wireless LAN AP or simply an AP hereinafter), is located at a position within a range that radio waves from the tethering terminal reach out of the coverage of the cell of the base station device. In such a case, the base station device cannot detect communication performed by the communication apparatus even though the communication apparatus serves as an interference source for the tethering terminal. In this case, the base station device is likely to allocate a frequency band that overlaps a frequency band used for communication through the wireless LAN for communication with the tethering terminal. There is a likelihood of LAA being operated by various communication carriers and sufficient cooperation between communication carriers not being performed because LAA is unlicensed. This also causes a high likelihood of allocating frequency bands overlapping between a PLMN and a wireless LAN.

With regard to this, Patent Document 1, for example, discloses a wireless device which reduces coexisting interference in cooperation with multiple wireless transceivers jointly installed in the device. The wireless device includes an LTE transceiver, a Bluetooth (BT) (registered trademark) transceiver or a Global Navigation Satellite System (GNSS) transceiver and performs communication simultaneously using the plurality of transceivers. In addition, the wireless device receives wireless signal information from transceivers to determine control information and reduces coexisting interference in a designated frequency channel using the control information. The wireless device requests handover to a base station device on the basis of information such as a frequency which interferes according to communication through a wireless LAN when the interference is reduced.

### PRIOR ART DOCUMENT

### Patent Document

### [Patent Document 1]

Japanese Unexamined Patent Application Publication (Translation of PCT Application) No. 2013-535139

### SUMMARY OF THE INVENTION

### Problem to be Solved by the Invention

However, when interference of radio waves is detected in an LAA band used for communication, a conventional tethering terminal transmits a handover request to a base station device using the band. Accordingly, the handover request does not arrive at the base station device due to the interference, and thus it is difficult to avoid interference of radio waves.

Several aspects of the present invention devised to solve this problem provide a terminal device, a base station device, a communication control method, and a program which can more efficiently avoid the influence of interference of radio waves in LAA communication.

### Means for Solving the Problems

Some aspects of the present invention are made to solve the above-described problem, and one aspect of the present invention is a terminal device including: a communication unit configured to perform communication using a first frequency band or a second frequency band different from the first frequency band; a wireless environment measuring unit configured to detect interference of radio waves used for the communication; and a communication control unit configured to control the communication, wherein the communication control unit is configured to transmit, to a base station device which performs communication using the second frequency band, interference information about a frequency band in which the wireless environment measuring unit has detected interference or wireless environment information including a request for change of a frequency band used for the communication, the transmission being performed in a case that interference is detected in the first frequency band.

### Effect of the Invention

According to several aspects of the present invention, it is possible to more efficiently avoid the influence of interference of radio waves in LAA communication.

### BRIEF DESCRIPTION OF THE DRAWINGS

FIG. 1 is a block diagram illustrating an example of a configuration of a communication system according to embodiments of the present invention.

FIG. 2 is a block diagram illustrating another example of the configuration of the communication system according to embodiments of the present invention.

FIG. 3 is a block diagram illustrating a configuration of a terminal device according to embodiments of the present invention.

FIG. 4 is a diagram illustrating an example of a center frequency.

FIG. 5 is a flowchart illustrating an example of a communication control process according to embodiments of the present invention.

### EMBODIMENTS FOR CARRYING OUT THE INVENTION

First, embodiments of the present invention will be described. FIG. 1 is a conceptual diagram illustrating an example of a configuration of a communication system 1 according to the present embodiment.

The communication system 1 includes a first terminal device 10, a second terminal device 20, an LAA band base station device 30A, and a licensed band base station device 30B.

The first terminal device 10 has communication functions of wirelessly transmitting and receiving user data through the LAA band base station device 30A to and from a destination apparatus (not shown) of a communication counterpart. For example, the communication functions include voice communication with a destination terminal device, message exchange (e-mail), acquisition of text data from webservers connected to the Internet (browsing), and the like. Data for information delivery with respect to such a communication counterpart corresponds to user data. In addition, in the example illustrated in FIG. 1, the first terminal device 10 transmits and receives control data to and from the licensed band base station device 30B. A frequency band used to transmit and receive user data differs from a frequency band used to transmit and receive control data. An LAA band (e.g., 5 GHz band) is used to transmit and receive the user data and a different frequency band (e.g., 2 GHz band) specified in LTE, that is, an LTE band, is used to transmit and receive the control data. LTE bands are provided as licensed bands which require a license.

In addition, the first terminal device 10 has functions of a wireless LAN AP. The first terminal device 10 performs communication with a second terminal device 20 having a wireless LAN terminal function using a predetermined communication scheme, for example, a scheme specified in IEEE 802.11. Further, the first terminal device 10 relays communication of the second terminal device 20 with a destination apparatus (not shown) through the LAA band base station device 30A. That is, the first terminal device 10 serves as a tethering terminal. For example, the first terminal device 10 is a mobile phone (including a so-called smartphone), a tablet terminal device, a wireless communication card or the like.

The LAA band base station device 30A provides communication through a PLMN to the first terminal device 10 located within a cell C01A that radio waves from the LAA band base station device 30A reach using an LAA band. The LAA band base station device 30A relays user data between the first terminal device 10 and a destination apparatus through a core network including the LAA band base station device 30A. The core network is a network connected to other networks, such as the Internet.

The licensed band base station device 30B provides communication through a PLMN to the first terminal device 10 located within a cell C01B that radio waves from the licensed band base station device 30B reach using a conventional LTE band. The licensed band base station device 30B transmits and receives various types of control data to and from the first terminal device 10 and to and from the core network. Accordingly, communication of user data between the licensed band base station device 30B and the first terminal device 10 is controlled.

The AP 40 provides communication through a wireless LAN to a terminal device located within a cell C02 which is a range that radio waves from the AP 40 reach. In the example illustrated in FIG. 1, the first terminal device 10 is located in the cell C02. There are cases in which a frequency band within an LAA band, which is used by the first terminal device 10 and the LAA band base station device 30A for communication of user data, is identical or similar to a frequency band used by the AP 40 for wireless LAN communication. In such cases, radio waves transmitted from the LAA band base station device 30A to the first terminal device 10 may interfere with radio waves used by the AP 40 for communication with other terminal devices even when the first terminal device 10 does not communication with the AP 40. Accordingly, control data may not arrive at the first terminal device 10 due to interference in a conventional communication system.

The first terminal device 10 can perform communication using a PLMN through the LAA band base station device 30A and the licensed band base station device 30B and tethering communication with the second terminal device 20 through a wireless LAN in parallel. Here, it is assumed that the first terminal device 10 uses a 5 GHz band for communication with the second terminal device 20, uses a 2 GHz band to transmit and receive control data to and from the licensed band base station device 30B and uses an LAA band (5 GHz band) to transmit and receive user data to and from the LAA band base station device 30A. The first terminal device 10 avoids interference by using different frequency bands within a 5 GHz band for tethering communication with the second terminal device 20 and user data communication with the LAA band base station device 30A using the LAA band. However, the first terminal device 10 is located near the cell edge of the cell C01A and within the coverage of the cell C02, whereas the LAA band base station device 30A and the licensed band base station device 30B are not located within the coverage of the cell C02. Accordingly, the LAA band base station device 30A and the licensed band base station device 30B cannot detect radio waves used for tethering communication between the first terminal device 10 and the second terminal device 20 and radio waves from the AP 40. In this manner, there were cases in which interference of radio waves cannot be avoided in the conventional communication system.

Accordingly, the first terminal device 10 detects interference of radio waves and generates frequency band exclusion information including information on an excluded frequency band which represents exclusion of a frequency band in which the interference has been detected from frequency bands allocated to the first terminal device 10. In the example illustrated in FIG. 1, two types of interference, mainly (i) interference of radio waves of a frequency band used for LAA communication between the first terminal device 10 and the LAA band base station device 30A and radio waves of frequency bands used by the AP 40 for communication with other terminal devices and (ii) interference of radio waves of a frequency band used for tethering communication between the first terminal device 10 and the second terminal device 20 and radio waves of frequency bands used by the AP 40 for communication with other terminal devices, may occur as interference of radio waves. The first terminal device 10 transmits control data including the frequency band exclusion information to the licensed band base station device 30B using a 2 GHz band which is a frequency band different from the excluded frequency band. Meanwhile, interference between LAA communication and tethering communication may be avoided by further adding the frequency band used for tethering communication between the first terminal device 10 and the second terminal device 20 to the frequency band exclusion information.

The licensed band base station device 30B sets any one of frequency bands which are different from the excluded frequency band indicated by the frequency band exclusion information included in the control data, which is notified of by the first terminal device 10, and are unused frequency bands that can be used by the first terminal device 10 as an allocated frequency band. The licensed band base station device 30B transmits control data including an allocated frequency band information indicating the set allocated frequency band to the first terminal device 10. The first terminal device 10 performs LAA communication with respect to user data with the LAA band base station device 30A using the frequency band set by the licensed band base station device 30B.

Accordingly, (i) interference of radio waves of the frequency band used for LAA communication between the first terminal device 10 and the LAA band base station device 30A and radio waves of frequency bands used by the AP 40 for communication with other terminal devices and (ii) interference of radio waves of the frequency band used for tethering communication between the first terminal device 10 and the second terminal device 20 and radio waves of frequency bands used by the AP 40 for communication with other terminal devices are avoided.

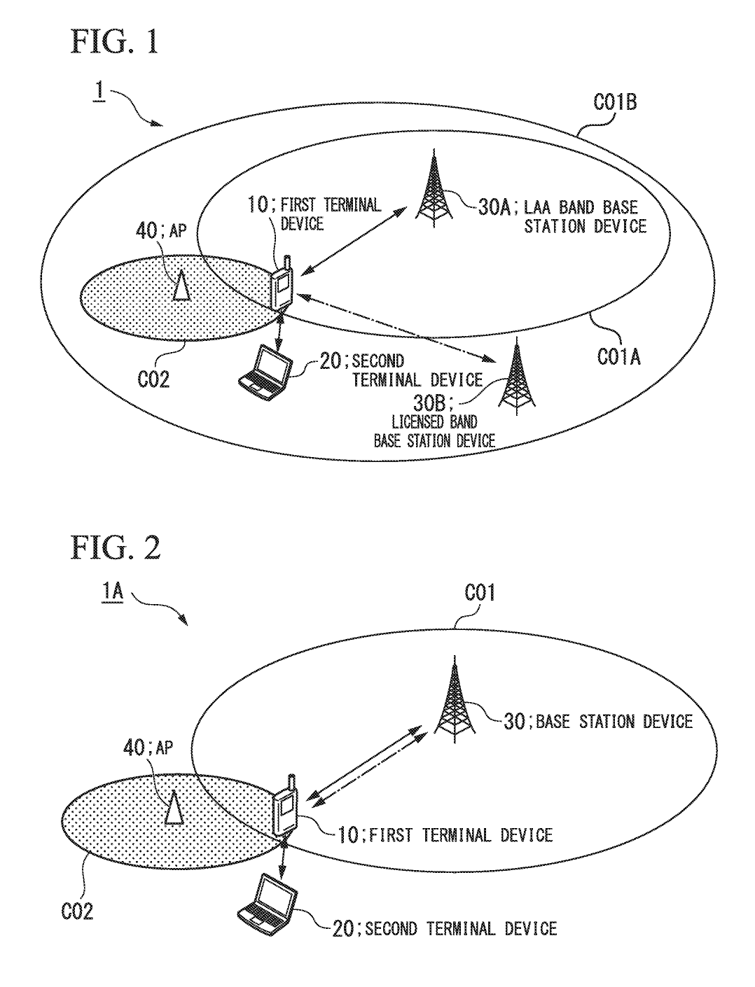

The LAA band base station device 30A may be configured as a single base station device 30 by being integrated with the licensed band base station device 30B and including the configuration of the licensed band base station device 30B, as illustrated in FIG. 2. Accordingly, the base station device 30 has a configuration for performing LAA communication with the first terminal device 10 with respect to user data using an LAA band and a configuration for performing communication with respect to control data using a licensed band. If the first terminal device 10 is located within the coverage of the cell C01 that radio waves from the base station device 30 reach, interference in tethering is avoided as in the example illustrated in FIG. 1.

Meanwhile, although there are one first terminal device 10, one second terminal device 20, one base station device 30, one LAA band base station device 30A, one licensed band base station device 30B and one AP 40 in the examples illustrated in FIGS. 1 and 2, there are a plurality of first terminal devices 10, a plurality of second terminal devices 20, a plurality of base station devices 30, a plurality of LAA band base station devices 30A, a plurality of licensed band base station devices 30B and a plurality of APs 40, in general. In the following description, a case in which mainly the LAA band base station device 30A and the licensed band base station device 30B are separately configured will be exemplified.

### (Configuration of First Terminal Device 10)

Next, a configuration of the first terminal device 10 will be described.

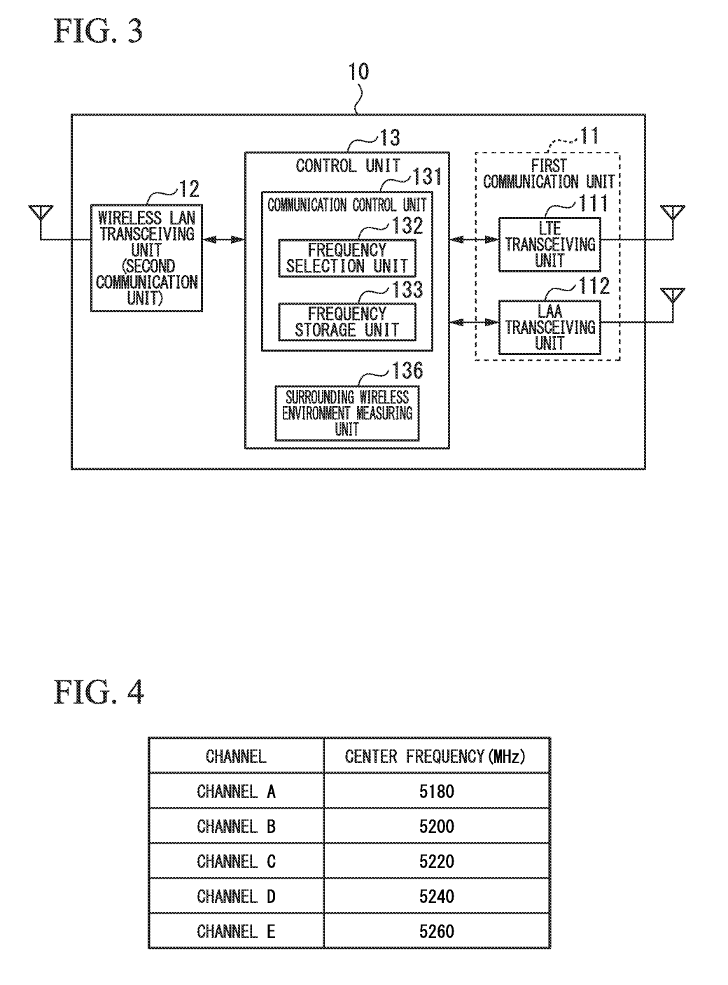

FIG. 3 is a block diagram illustrating a configuration of the first terminal device 10 according to the present embodiment.

The first terminal device 10 includes a first communication unit 11, a wireless LAN transceiving unit (second communication unit) 12, and a control unit 13. The first communication unit 11 includes an LTE transceiving unit 111 and an LAA transceiving unit 112. The LTE transceiving unit 111 wirelessly transmits and receives various types of data to and from the licensed band base station device 30B using a licensed band as a frequency band through a method specified in LTE. The LAA transceiving unit 112 wirelessly transmits and receives various types of data to and from the LAA band base station device 30A using an LAA band which is an unlicensed band as a frequency band through a method specified in LTE. In this manner, LAA communication is realized.

The wireless LAN transceiving unit 12 performs data communication with another terminal device as a wireless LAN AP using a communication scheme specified in IEEE 802.11, for example, as a wireless LAN communication standard. For example, the first communication unit 11 and the wireless LAN transceiving unit 12 are communication interfaces and are connected to antennas. Meanwhile, any or all of the first communication unit 11 and the wireless LAN transceiving unit 12 may be collectively called a communication unit in the following description. In addition, transmission and reception of various types of data between the control unit 13 and other apparatuses through the communication unit may not be particularly mentioned.

The control unit 13 includes a communication control unit 131 and a surrounding wireless environment measuring unit 136. For example, the control unit 13 includes a processing apparatus such as a central processing unit (CPU) and a storage medium such as a random access memory (RAM). The control unit 13 may realize functions of the communication control unit 131, the surrounding wireless environment measuring unit 136 and the like by executing commands instructed through a predetermined program.

The communication control unit 131 controls communication in which the first terminal device 10 serves as a transmission source or a reception destination. The communication control unit 131 further performs control with respect to tethering which is a function of relaying communication between the first terminal device 10 and the second terminal device 20 to the base station device 30. As such control, the communication control unit 131 performs processing related to initiation and termination of transmission and reception of data, request and change of a frequency band, and the like. The communication control unit 131 transmits a surrounding frequency band report signal generated by the surrounding wireless environment measuring unit 136 to the licensed band base station device 30B. The licensed band base station device 30B allocates a frequency band different from a surrounding frequency band indicated by the surrounding frequency band report signal from the first terminal device 10 among available frequency bands. The licensed band base station device 30B transmits a handover indication signal which represents transition (handover) from a frequency band which is being used to the allocated frequency band to the first terminal device 10. The communication control unit 131 performs a synchronization process between the first terminal device 10 and an LAA band base station device 30A′ of a movement destination according to handover which can use a frequency band designated by the handover indication signal from the licensed band base station device 30B. Accordingly, the LAA band base station device 30A′ is connected to the first terminal device 10 as a base station of the movement destination.

The communication control unit 131 includes a frequency selection unit 132 and a frequency storage unit 133. The frequency storage unit 133 stores a center frequency, which represents a frequency band of each channel in an LAA band, in advance for each channel.

The frequency selection unit 132 decides a frequency band of radio waves used for wireless LAN communication on the basis of instruction of a user, or the like. The frequency selection unit 132 selects a center frequency corresponding to the decided frequency band from candidates of center frequencies stored in the frequency storage unit 133 in advance. The frequency selection unit 132 generates a selected frequency report signal indicating the selected center frequency. The communication control unit 131 causes the wireless LAN transceiving unit 12 to perform wireless LAN communication using a frequency band designated by the center frequency indicated by the selected frequency report signal. Further, the frequency selection unit 132 may select a frequency band which is not used for communication performed around the first terminal device 10 on the basis of a measurement result of the surrounding wireless environment measuring unit 136.

The surrounding wireless environment measuring unit 136 measures a frequency band used for communication on the basis of electric signals according to radio waves received by antennas connected to the LTE transceiving unit 111, the LAA transceiving unit 112 and the wireless LAN transceiving unit 12. The antennas receive radio waves from the AP 40 and various other apparatuses around the first terminal device 10. For example, the surrounding wireless environment measuring unit 136 acquires electric field intensity of each frequency and sets a frequency band in which the acquired electric field intensity is higher than a predetermined electric field intensity. The surrounding wireless environment measuring unit 136 detects interference with respect to the frequency band used for communication. For example, the surrounding wireless environment measuring unit 136 calculates a peak to average power ratio (PAPR) with respect to a frequency band which is a determination target. In addition, the surrounding wireless environment measuring unit 136 determines that interference has occurred when the calculated PAPR is equal to or higher than a predetermined PAPR threshold value and determines that interference has not occurred when the calculated PAPR is lower than the predetermined PAPR threshold value. The surrounding wireless environment measuring unit 136 generates a surrounding frequency band report signal including the frequency band used for communication and information indicating presence or absence of interference.

### (Center Frequency)

Next, an example of center frequencies stored in the frequency storage unit 133 will be described.

FIG. 4 is a diagram illustrating an example of center frequencies. In the example illustrated in FIG. 4, center frequencies of five channels A to E are 5,180, 5,200, 5,220, 5,240 and 5,260 MHz. A frequency interval between channels is 20 MHz. Any frequency band is included in a 5 GHz band which is an LAA band used for LAA communication. In the present embodiment, a frequency band used for LAA communication is specified with channels or a center frequency corresponding to each channel.

Here, when any frequency band within a 5 GHz band is used for wireless LAN communication between the first terminal device 10 and the second terminal device 20, there is a likelihood of the base station device 30 allocating a frequency band including part or all of the frequency band for LAA communication with the first terminal device 10.

In the present embodiment, interference which may occur due to allocation of such a frequency band is avoided according to a communication control process which will be described below.

### (Communication Control Process)

Next, an example of a communication control process according to the present embodiment will be described.

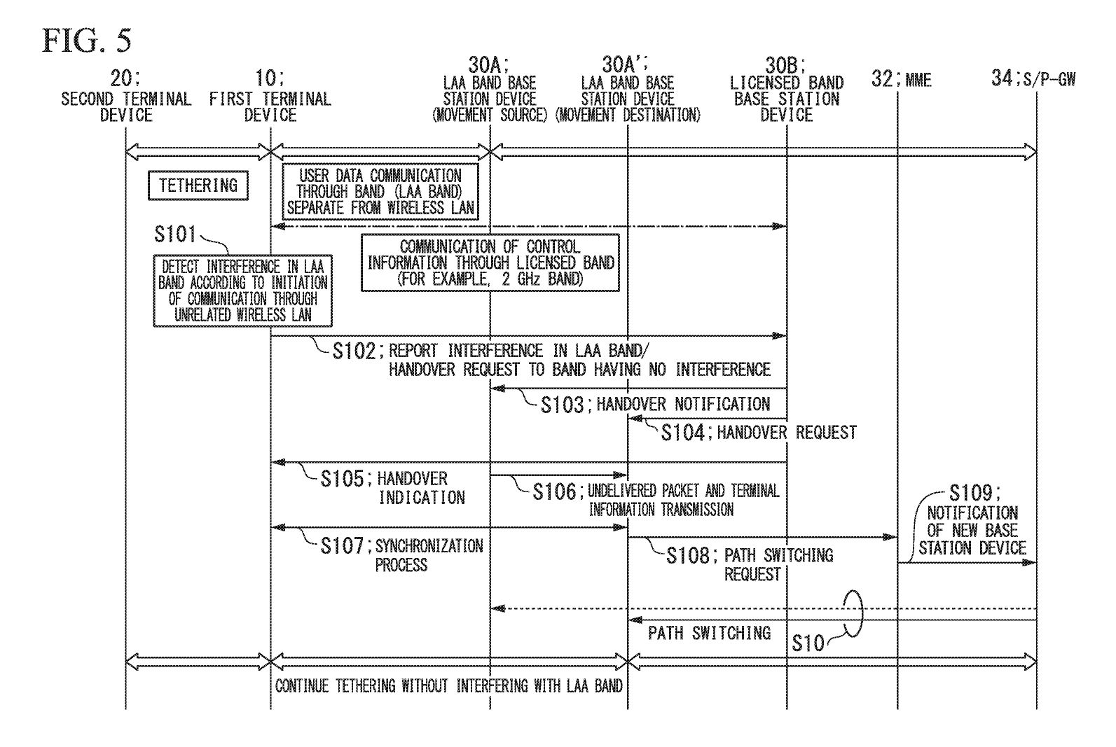

FIG. 5 is a sequence diagram illustrating an example of the communication control process according to the present embodiment.

The process illustrated in FIG. 5 is executed among the first terminal device 10, the second terminal device 20, the LAA band base station devices 30A and 30A′, the licensed band base station device 30B, a mobility management entity (MME) 32 and a serving/packet data network gateway (S/P-GW) 34. The LAA band base station devices 30A and 30A′ respectively correspond to a base station device (movement source cell) of a movement source and a base station device (movement destination cell) of a movement destination in handover.

The LAA band base station devices 30A and 30A′ and the licensed band base station device 30B are connected in a wired manner, and a core network having these base station devices includes the MME 32 and the S/P-GW 34. Handover illustrated in FIG. 5 is an example of X2 handover including a sequence of directly transmitting and receiving various types of control data between base station devices. The MME 32 performs management of movement of a terminal device located within a cell of each base station device and a process of setting a transmission path of user data between each base station device and the S/P-GW 34. The S/P-GW 34 transmits user data received from a terminal device of a transmission source through a base station device to a base station device having a cell in which a terminal device of a transmission destination is located or a network in which the terminal device of the transmission destination is accommodated.

In the process illustrated in FIG. 5, a case in which interference is detected in a frequency band used by the first terminal device 10 for transmission and reception of user data to and from the LAA band base station device 30A during tethering (relaying) of communication performed between the second terminal device 20 and a destination device is exemplified. An LTE band (e.g., 2 GHz band) is used as a frequency band used for transmission and reception of control data between the first terminal device 10 and the licensed band base station device 30B, and a wireless LAN frequency band (e.g., 5 GHz band) is used as a frequency band used for communication between the first terminal device 10 and the second terminal device 20. Here, this frequency band differs from the frequency band used for communication of user data with respect to the licensed band base station device 30B. Accordingly, interference does not occur between frequency bands used for tethering. The LAA band base station devices 30A and 30A′ respectively correspond to a base station device (movement source cell) of a movement source and a base station device (movement destination cell) of a movement destination in handover.

FIG. 5 is a sequence diagram illustrating an example of the communication control process according to the present embodiment.

(Step S101) The surrounding wireless environment measuring unit 136 of the first terminal device 10 determines whether interference has occurred with respect to a frequency band used for communication with the LAA band base station device 30A among radio waves received from surrounding apparatuses. Then, the process proceeds to step S102.

(Step S102) When the surrounding wireless environment measuring unit 136 detects interference in the frequency band used for communication with the LAA band base station device 30A, the communication control unit 131 of the first terminal device 10 transmits a surrounding frequency band report signal indicating the frequency band in which the interference has been detected to the licensed band base station device 30B. Interference in a frequency band used for communication between the first terminal device 10 and the second terminal device 20 may occur when the AP 40 which is separated from the second terminal device 20 performs communication using a frequency band of a wireless LAN. The surrounding frequency band report signal may further include information on a frequency band used by the first terminal device 10 for tethering communication, and information on frequency bands which can be used for transmission and reception of various types of data as capabilities of the first terminal device 10. The communication control unit 131 may transmit a handover request signal (HO request) instead of or along with the surrounding frequency band report signal to the licensed band base station device 30B. The handover request signal indicates instruction of handover to a frequency band which does not generate interference among frequency bands which can be used by the first terminal device 10 for transmission and reception of data. Thereafter, the process proceeds to step S103.

(Step S103) The licensed band base station device 30B transmits a frequency band inquiry signal to the LAA band base station device 30A upon receiving the surrounding frequency band report signal or the handover request signal from the first terminal device 10. The frequency band inquiry signal is a signal for inquiring about presence or absence of an available frequency band in which interference is not detected among unused frequency bands.

The LAA band base station device 30A determines presence or absence of an available frequency band and transmits a response signal indicating presence or absence of the available frequency band to the licensed band base station device 30B. When the response signal received from the LAA band base station device 30A indicates that there is no available frequency band, the licensed band base station device 30B determines that handover is performed and selects the LAA band base station device 30A′ as a movement destination cell. As the movement destination cell, a base station device which includes a frequency band available for transmission and reception of data to and from the first terminal device 10 as an unused frequency band and includes the location of the first terminal device 10 within the cell, and a frequency band (band to be used) used for transmission and reception of data are selected. Meanwhile, when the surrounding frequency band report signal includes information on a frequency used for tethering communication, a band to be used may be selected from frequency bands obtained by further excluding the frequency band used for tethering communication from the unused frequency bands. The licensed band base station device 30B transmits a handover notification signal (HO request) indicating handover to the LAA band base station device 30A′ to the LAA band base station device 30A. Thereafter, the process proceeds to step S104.

Further, when the response signal received from the LAA band base station device 30A indicates that there is an available frequency band in step S103, the licensed band base station device 30B determines that handover is not performed. In this case, the licensed band base station device 30B transmits, to the LAA band base station device 30A, a frequency band change signal indicating change to an available frequency band different from a frequency band used for communication with the first terminal device 10 at that time. The LAA band base station device 30A receives the frequency band change signal from the licensed band base station device 30B, and then changes the frequency band used at that time to the available frequency band different from the frequency band. Subsequently, the LAA band base station device 30A transmits and receives user data to and from the first terminal device 10 using the changed frequency band. Then, the process illustrated in FIG. 5 is ended.

(Step S104) The licensed band base station device 30B transmits a handover request signal indicating a handover request from the LAA band base station device 30A and a band to be used to the LAA band base station device 30A′. Then, the process proceeds to step S105.

(Step S105) The licensed band base station device 30B transmits a handover instruction signal (HO instruction) indicating initiation of handover and the band to be used to the first terminal device 10. Then, the process proceeds to step S106.

(Step S106) The LAA band base station device 30A transmits an undelivered packet and terminal information for identifying the first terminal device 10 to the LAA band base station device 30A′. The undelivered packet is a packet storing user data which is addressed to the first terminal device 10 as a transmission destination but has not been transmitted. Then, the process proceeds to step S107.

(Step S107) The first terminal device 10 and the LAA band base station device 30A′ perform a synchronization process. Thereafter, the process proceeds to step S108.

(Step S108) The LAA band base station device 30A′ transmits, to the MME 32, a path switching request signal indicating switching between the LAA band base station device 30A′ and the S/P-GW 34 for a path with respect to transmission and reception of user data. Then, the process proceeds to step S109.

(Step S109) The MME 32 transmits, to the S/P-GW 34, a base station notification signal indicating the LAA band base station device 30A as a new base station device replacing the LAA band base station device 30A in response to reception of the path switching request signal from the LAA band base station device 30A′. Then, the process proceeds to step S110.

(Step S110) The S/P-GW 34 switches the LAA band base station device 30A as a connection destination related to transmission and reception of user data to the LAA band base station device 30A′ in response to reception of the base station notification signal from the MME 32. Then, the process illustrated in FIG. 5 is ended.

Even when interference occurs in a frequency band within the LAA band used for transmission and reception of user data between the first terminal device 10 and the LAA band base station device 30A according to the process illustrated in FIG. 5, tethering communication is continued using other frequency bands in which interference does not occur.

Meanwhile, although a case of handover based on X1 handover is exemplified in the aforementioned process, the aforementioned process may be applied to SI handover having a sequence of transmitting and receiving control data through a core network.

In addition, in step S103, the licensed band base station device 30B may terminate LAA communication and perform user data communication using a licensed band when it is determined that handover to the LAA band base station device 30A′ which can use a frequency at which interference is not detected is impossible. More specifically, when it is determined that there is no frequency band which can be used by the LAA band base station device 30A and there is no LAA band base station device 30A′ having an available frequency band near the licensed band base station device 30B, the licensed band base station device 30B allocates a frequency band used for transmission and reception of user data from unused licensed bands thereof.

It is determined that there is no available frequency band when frequency bands remaining after exclusion of a frequency band which is indicated by a surrounding frequency band report signal and has interference detected therein and a frequency band used for tethering from unused frequency bands are insufficient as frequency bands used for user data communication. The licensed band base station device 30B transmits, to the first terminal device 10, a frequency band allocation signal indicating an allocated frequency band instead of the handover indication signal. Subsequently, the first terminal device 10 transmits and receives user data to and from the licensed band base station device 30B using the frequency band indicated by the frequency band allocation signal. In addition, the licensed band base station device 30B relays the user data between the first terminal device 10 and a destination apparatus.

In addition, in step S105, when the frequency band used for tethering communication has been designated by the licensed band base station device 30B, the communication control unit 131 of the first terminal device 10 may change the frequency band used for tethering communication to an unused frequency band in which interference is not detected. More specifically, the communication control unit 131 of the first terminal device 10 determines whether part or all of the frequency band indicated by the handover indication signal received from the licensed band base station device 30B overlaps the frequency band used for tethering communication with the second terminal device 20. When it is determined that the frequency bands overlap, the communication control unit 131 of the first terminal device 10 changes the frequency band used for tethering communication to an available frequency band remaining after exclusion of the frequency band indicated by the handover indication signal and a frequency band in which the surrounding wireless environment measuring unit 136 has detected interference from frequency bands which are not used for wireless LAN communication. Then, the wireless LAN transceiving unit 12 of the first terminal device 10 transmits and receives user data to and from the second terminal device 20 using the changed frequency band.

Meanwhile, in the above-described example, the licensed band base station device 30B determines presence or absence of frequency bands available for execution of handover and other base station devices having the available frequency bands. Accordingly, the handover request signal transmitted by the communication control unit 131 may not necessarily designate a base station device of a movement target. In addition, a base station device of a movement target according to handover is not necessarily limited to other LAA band base station devices 30A′. For example, when it is determined that the licensed bands of the licensed band base station device 30B do not include frequency bands available for other LAA band base station devices 30A′, the licensed band base station device 30B may designate another licensed band base station device 30B′ as a base station device of a movement target.

As described above, the first terminal device 10 according to the present embodiment includes the first communication unit 11 which performs communication through a PLMN using an LTE scheme and the wireless LAN transceiving unit 12 which performs communication through a wireless LAN. In addition, the first terminal device 10 includes the surrounding wireless environment measuring unit 136 which detects interference of radio waves used for communication and the communication control unit 131 which controls communication. When interference is detected in a frequency band within LAA bands used for communication through a PLMN, the communication control unit 131 causes the first communication unit 11 to transmit surrounding frequency band information including the frequency band in which interference is detected to the licensed band base station device 30B of a first network using a licensed band different from the frequency band within the LAA bands. In addition, the communication control unit 131 changes the first frequency band to a frequency band which is notified of by the licensed band base station device 30B and differs from frequency bands within the LAA bands used for communication and frequency bands of the wireless LAN.

According to this configuration, when interference has occurred in a frequency band within LAA bands, an electronic apparatus different from the second terminal device 20 performs communication through a wireless LAN to change the frequency band to a frequency band in which interference does not occur. Accordingly, it is possible to avoid the influence of interference of radio waves in LAA communication.

Furthermore, when interference is detected in a frequency band within the LAA bands, the communication control unit 131 transmits a handover request signal indicating a request for change of the frequency band to the licensed band base station device 30B.

According to this configuration, frequency band change which accompanies change of the LAA band base station device 30A can be performed through a core network having the licensed band base station device 30B. Accordingly, it is possible to efficiently use limited network resources.

In addition, the first communication unit 11 uses frequency bands within LAA bands for communication of user data through the first network and the wireless LAN transceiving unit 12 uses frequency bands within licensed bands for communication of control data including surrounding frequency band information.

According to this configuration, a frequency band within licensed bands remarkably different from frequency bands of a wireless LAN is used in control data communication, and thus reliability is secured in control data communication which requires high-accuracy transmission and reception. This is compatible with economic feasibility obtained by using a frequency band within LAA bands for communication of a larger amount of user data than the control data.

In addition, the communication control unit 131 causes the wireless LAN transceiving unit 12 to perform communication with the second terminal device 20 through a wireless LAN and relays the communication and communication through a PLMN.

According to this configuration, it is possible to avoid the influence of interference due to communication through a wireless LAN in tethering.

### MODIFIED EXAMPLES

Although embodiments of the present invention have been described in detail with reference to the drawings above, specific configurations are not limited to those described above and various design changes and the like can be made in the present invention without departing from the spirit or scope of the invention.

For example, the first communication unit 11 may be configured as a single communication unit integrated with the wireless LAN transceiving unit 12. The LAA transceiving unit 112 of the first communication unit 11 may be configured as a single transceiving unit integrated with the LTE transceiving unit 111.

Further, any one of the aforementioned frequencies or frequency bands is exemplary and other frequencies or frequency bands may be used.

Meanwhile, the above-described embodiments can be embodied in the following aspects.

(1) A terminal device including a communication unit configured to perform communication using a first frequency band or a second frequency band different from the first frequency band; a wireless environment measuring unit configured to detect interference of radio waves used for the communication; and a communication control unit configured to control the communication, wherein the communication control unit is configured to transmit, to a base station device which performs communication using the second frequency band, interference information about a frequency band in which the wireless environment measuring unit has detected interference or wireless environment information including a request for change of a frequency band used for the communication, the transmission being performed in a case that interference is detected in the first frequency band.

(2) In the terminal device of (1), the request for change of the frequency band is a handover request.

(3) In the terminal device of (1) or (2), the communication unit is configured to use the first frequency band for communication of user data and uses the second frequency band for communication of control data.

(4) In the terminal device of any one of (1) to (3), the communication unit is further configured to perform communication using a third frequency band according to a communication scheme different from communication using the first frequency band, and wireless environment information further includes information about the third frequency band.

(5) A base station device configured to perform communication with the terminal device of any one of (1) to (4) using the second frequency band and is configured to notify the terminal device of using a frequency band different from the first frequency band for communication in a case that the wireless environment information has been received from the terminal device.

(6) A base station device configured to perform communication with the terminal device of any one of (1) to (4) using the second frequency band and is configured to notify the terminal device of initiation of handover in a case that the wireless environment information has been received from the terminal device.

(7) A communication control method including: performing communication using a first frequency band or a second frequency band different from the first frequency band; detecting interference of radio waves used for the communication; and transmitting, to a base station device which performs communication using the second frequency band, interference information about a frequency band in which interference has been detected or wireless environment information including a request for change of a frequency band used for the communication, the transmission being performed in a case that interference is detected in the first frequency band.

(8) A program for causing a computer to execute the communication control method of (7).

Meanwhile, a part of the first terminal device 10, for example, the control unit 13, may be realized using a computer. In this case, the control unit 13 may be realized in such a manner that a program for realizing the control function of the control unit 13 is recorded in a computer-readable recording medium and a computer system is caused to read and execute the program.

In addition, part or all of the first terminal device 10 in the above-described embodiments may be realized as an integrated circuit such as a large scale integration (LSI) circuit. Each functional block of a part of the first terminal device 10 may be individually configured as a processor, or some or all of functional blocks may be integrated into a processor. Further, integration techniques are not limited to LSI and the devices may be realized as dedicated circuits or general-purpose processors. Further, when an integration technology which replaces LSI appears with the advancement of semiconductor technology, integrated circuits according to the technology may be used.

### INDUSTRIAL APPLICABILITY

Several aspects of the present invention can be applied to a terminal device, a base station device, a communication control method and the like which require more efficient avoidance of the influence of interference of radio waves in LAA communication.

### DESCRIPTION OF THE REFERENCE SYMBOLS

1, 1A Communication system
10 First terminal device
11 First communication unit
111 LTE transceiving unit
112 LAA transceiving unit
12 Wireless LAN transceiving unit
13 Control unit
131 Communication control unit
132 Frequency selection unit
133 Frequency storage unit
136 Surrounding wireless environment measuring unit
20 Second terminal device
30 Base station device
40 AP

1. A terminal device comprising:
a communication unit configured to perform communication using a first frequency band or a second frequency band different from the first frequency band;
a wireless environment measuring unit configured to detect interference of radio waves used for the communication; and
a communication control unit configured to control the communication,
wherein the communication control unit is configured to transmit, to a base station device which performs communication using the second frequency band, interference information about a frequency band in which the wireless environment measuring unit has detected interference or wireless environment information including a request for change of a frequency band used for the communication, the transmission being performed in a case that interference is detected in the first frequency band.

2. The terminal device according to claim 1,
wherein the request for change of the frequency band is a handover request.

3. The terminal device according to claim 1,
wherein the communication unit is configured to use the first frequency band for communication of user data and uses the second frequency band for communication of control data.

4. The terminal device according to claim 1,
wherein the communication unit is further configured to perform communication using a third frequency band according to a communication scheme different from communication using the first frequency band, and
wherein the wireless environment information further includes information about the third frequency band.

5. A base station device configured to perform communication with the terminal device according to claim 1 using the second frequency band,
wherein the base station device is configured to notify the terminal device of using a frequency band different from the first frequency band for communication in a case that the wireless environment information has been received from the terminal device.

6. A base station device configured to perform communication with the terminal device according to claim 1 using the second frequency band,
wherein the base station device is configured to notify the terminal device of initiation of handover in a case that the wireless environment information has been received from the terminal device.

7. A communication control method comprising:
performing communication using a first frequency band or a second frequency band different from the first frequency band;
detecting interference of radio waves used for the communication; and
transmitting, to a base station device which performs communication using the second frequency band, interference information about a frequency band in which interference has been detected or wireless environment information including a request for change of a frequency band used for the communication, the transmission being performed in a case that interference is detected in the first frequency band.

8. A non-transitory computer readable medium storing a program for causing a computer to execute the communication control method according to claim 7.
